(19) United States
(12) Patent Application Publication
(10) Pub. No.: US 2010/0063907 A1
(43) Pub. Date: Mar. 11, 2010

(54) Insurance Billing System

(75) Inventors: Arun Savani, North Wales, PA (US); Vinay Pandya, North Wales, PA (US)

Correspondence Address: Carlineo, Spicer & Kee, LLC, 2003 S. Easton Road, Suite 208, Doylestown, PA, 18901, US

(73) Assignee: American Management Group, LLC

(21) Appl. No.: 12/558,024

(22) Filed: Sep. 11, 2009

Related U.S. Application Data
(60) Provisional application No. 61/096,036, filed on Sep. 11, 2008.

(51) Int. Cl. G06Q 30/00

(52) U.S. Cl. 705/30; 705/4

(57) ABSTRACT

A method and system of billing consumers for services rendered by a service provider includes determining at least one service to be rendered to the consumer and identifying at least one code corresponding to the service. A confidence level is determined for each of the at least one codes. A code is assigned to each of the services, with each code corresponding to the respective service and being based at least in part on the corresponding confidence level. An estimated consumer balance for the services rendered is determined in view of the assigned code.

### CROSS REFERENCE TO RELATED APPLICATION

This application claims the benefit of U.S. Provisional Patent Application No. 61/096,036, filed Sep. 11, 2008, and entitled Insurance Billing System, the entire disclosure of which is incorporated herein by reference.

### BRIEF DESCRIPTION OF THE DRAWINGS

The following detailed description will be better understood when read in conjunction with the appended drawings, in which there is shown one or more of the multiple embodiments of the present disclosure. It should be understood, however, that the various embodiments of the present disclosure are not limited to the precise arrangements and instrumentalities shown in the drawings.

In the Drawings:

FIG. 1 is a use case diagram of an insurance billing system in accordance with one embodiment of the present disclosure;

FIG. 2 is a use case diagram of a confidence level system in accordance with the insurance billing system of FIG. 1;

FIG. 3 is a flow chart in accordance with the insurance billing system of FIG. 1;

FIG. 4 is a system diagram in accordance with the insurance billing system of FIG. 1;

FIG. 5 is a block diagram of a computer system for realization of the insurance billing system of FIG. 1; and

FIG. 6 is a block diagram of a computer system for realization of the insurance billing system of FIG. 1.

### DETAILED DESCRIPTION

Certain terminology is used herein for convenience only and is not to be taken as a limitation on the embodiments of the present disclosure. In the drawings, the same reference letters are employed for designating the same elements throughout the several figures.

Unified Modeling Language (“UML”) can be used to model and/or describe methods and systems and provide the basis for better understanding their functionality and internal operation as well as describing interfaces with external components, systems and people using standardized notation. When used herein, UML diagrams including, but not limited to, use case diagrams, class diagrams and activity diagrams, are meant to serve as an aid in describing the embodiments of the present disclosure, but do not constrain implementation thereof to any particular hardware or software embodiments.

The insurance billing system described herein relates to managing a service provider, entity or facility, and more particularly to filing claims with and/or receiving payment from insurance companies for services rendered by the service provider. The insurance billing system determines insurance codes under which to bill services that the provider has rendered or will render in the future, to ensure that payment received from the insurance company is maximized (regardless of whether such payment is made to the consumer or directly to the provider). The insurance billing system provides the user or provider with a confidence level for each code, indicating likelihood of receiving payment for a particular service using the chosen insurance code(s). Stated differently, the insurance billing system effectively predicts the ability to collect payments for a specific service. Thus, the insurance billing system permits a provider to accurately and efficiently file insurance claims and bill patients, maximizing collection from patients and insurance companies and minimizing losses to the provider (e.g., from non-payment of balances from the consumer or insurance companies). The insurance billing system is applicable to and may be implemented with respect to healthcare service providers and offices (e.g., physicians, dentists, etc.), automobile insurance claim filing, personal property or homeowners insurance, or any other type of service that includes filing insurance claims with claim codes corresponding to the services rendered. For exemplary purposes, the insurance billing system is described herein with respect to a dental service provider and/or as implemented in a dental office, but is not limited to dental practice.

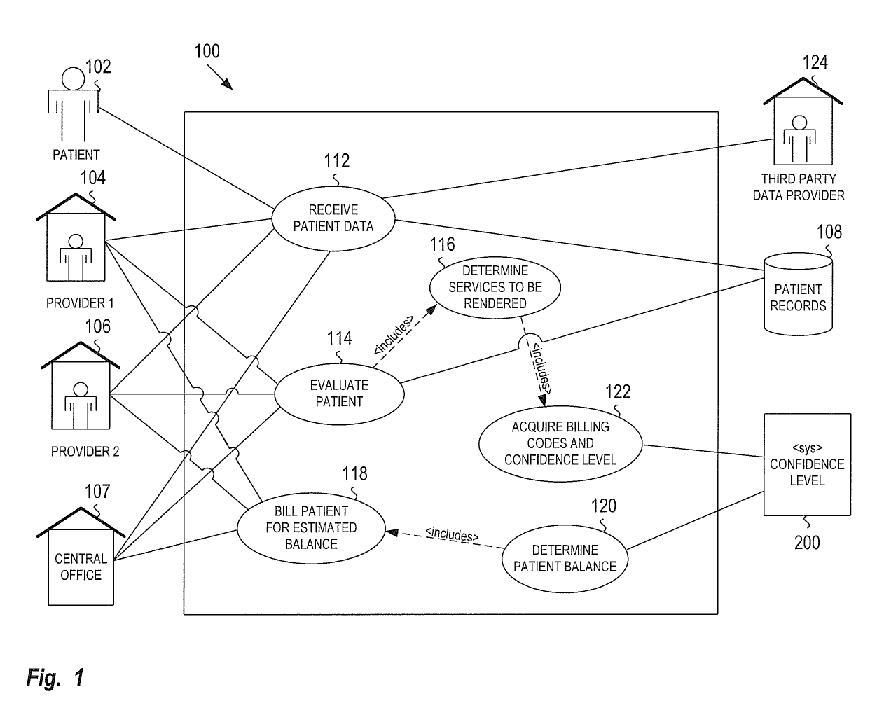

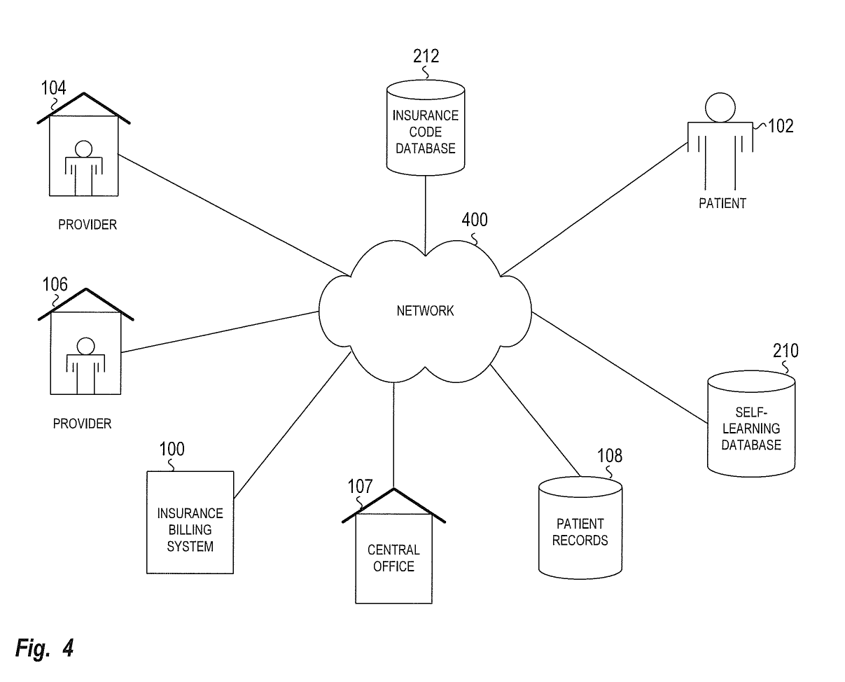

FIGS. 1 and 4 are use-case and system diagrams, respectively, for the insurance billing system 100 in accordance with one embodiment of the present disclosure. The insurance billing system 100 includes a receive patient data use case 112 that obtains patient data from patients 102 and/or providers 104, 106. A provider 104, 106 may be a physician, dentist, eye doctor, surgeon or other healthcare provider, an auto mechanic, auto dealer, technician, insurance agent or generally any other provider of services rendered to a patient or consumer. The provider 104, 106 may also include an entity, office or site where the services are rendered, such as a heath care facility (e.g., doctor's office, hospital or health clinic) or an auto repair shop, a group of such facilities, or a headquarters or centralized location for individual facilities. The patient 102 is a person, consumer or entity (e.g., a business) that has or will receive services from the provider 104, 106. For example, the patient 102 may be a patient receiving healthcare or dental services, a vehicle owner or a consumer receiving any other service. The data obtained in the receive patient data use case 112 includes patient name, address, contact information, medical history, insurance information, appointment information, patient preferences or any other relevant information toward providing services and processing the patient's files, records or bill. The patient data is input to the insurance billing system 100 through any one or combination of input devices or methods generally known in the art, including direct keyboard entry by the patient 102 or service provider 104, 106, touch-screen, web or other graphical user interface, or electronic wired or wireless transfer of data from other sources, such as existing data from the patient 102 (e.g., via email or download from a cell phone or personal data assistant (PDA)), service providers 104, 106, third-party data providers 124 (e.g., data collection organizations, insurance or medical associations, remote data services, etc.) or the central office 107. In one embodiment the patient data is received and/or stored in an encrypted format. The central office 107 may be a physical site where the insurance billing system 100 is monitored. The central office 107 may be located in one physical place, with an electronic presence in many places or be distributed over multiple physical locations. In one embodiment, the patient data is collected entirely at the central office.

The receive patient data use case 112 interfaces with a patient records database 108 that electronically stores patient files, records and other information. To the extent that a record for a particular patient 102 already exists in the records database 108, the receive patient data use case 112 retrieves the relevant records from the records database 108 and updates those records with the received patient data. Otherwise, the receive patient data use case 112 populates the patient records database 108 as required to create new or additional patient records. The patient records database 108 may reside on a PC or server, or distributed servers. As shown in FIG. 4, the records database 108 resides remotely from both the central office 107 and the service providers 104, 106 and is accessed via any known methodology (e.g., wired or wireless network, Internet, etc.). However those skilled in the art will recognize that the records database 108 may reside internally at the central office 107, the providers 104, 106 or be split over a combination thereof.

The network 400 (see FIG. 4) facilitates communication between the various devices, modules and components of the insurance billing system 100. The network 400 may be any network or system generally known in the art, including the Internet, an intranet, a local area network (LAN), a wide area network (WAN), a metropolitan area network (MAN), a direct connection or series of connections, a cable television infrastructure, a cellular telephone network or any other network, transmission channel or medium capable of facilitating communication between the devices, modules and other components of the insurance billing system 100. The network may be wired, wireless or a combination thereof. Wired connections may be implemented using Ethernet, Universal Serial Bus (USB), RJ-11 or any other wired connection generally known in the art. Wireless connections may be implemented using wifi, wimax, bluetooth, infrared, cellular networks, satellite or any other wireless connection methodology generally known in the art. The network maybe implemented in a client-server, token-ring, peer-to-peer manner or any other network topology known in the art. Additionally, several networks may work alone or in communication with each other to facilitate communication in the network 400. For example, a cellular phone network (not shown) may be used for receiving patient data and the Internet may be used to access the patient records storage device 108. Various networking standards may be employed for allowing the various systems and actors in and around the insurance billing system 100, including the patient records storage device 108, the third party data provider 124 and the confidence level system 200 (both discussed in greater detail below) to communicate with the network 400, such as EDGE, 3G and/or 802.11.

The insurance billing system 100 includes an evaluate patient use case 114 to obtain information regarding what issue(s) need to be resolved, such as patient pain or a consumer complaint. The evaluate patient use case 114 permits the provider 104, 106 to receive and record detailed information from the patient about the problem, ask questions, make observations, conduct an examination, run tests or other diagnostics, make notes, review and update the patient records, and generally obtain any information that the provider might need to make a decision, render a diagnosis, identify further concerns and/or formulate a course of action. For example, if a patient arrives at a dentist complaining of a toothache, the provider 104, 106 (i.e., the dentist) may review the patient's chart (if an existing patient), listen to the patient's complaint about which tooth is causing pain, assess the level of pain, conduct an examination of the patient's teeth and arrive at least at a preliminary diagnosis and/or determination of treatment (e.g., cavity in need of a filling or a tooth in need of extraction). The provider 104, 106 will make all of the appropriate notations and input them into the insurance billing system 100 through any one or combination of input devices or methods generally known in the art, including direct keyboard entry by the service provider 104, 106, touch-screen, web or other graphical user interface. The provider 104, 106 may enter the services to be rendered as text or choose from a menu of pre-determined services, in the process updating the patient's records. In the alternative the provider may make non-electronic documentation (i.e., traditional handwritten charts) of the evaluation and pass the documentation to another individual to convert the documentation into electronic form. The non-electronic document may be scanned into the system or input manually via keyboard entry. Yet another alternative is to input the notation via voice recognition by having the provider input or record evaluation notations into the system via voice recognition. Electronic input of the notations may result in a format of text that the system will parse in order to identity procedures performed or to be performed. Alternatively, the procedures may be individually and directly identified during input into the system.

The evaluate patient use case 114 includes a determine services to be rendered use case 116 that enables the provider 104, 106 to create a treatment plan for the patient and determine how the relevant insurance companies should be billed. The determine services to be rendered use case 116 thus determines what services the provider will render or proposes to render to the patient (i.e., the treatment plan). As part of this process, the determine services to be rendered use case 116 also determines what insurance claims will need to be filed presently or in the future with which insurance companies and under which particular codes, such that the patient 102 or the provider 104, 106 rendering the service receives payment for the treatment plan, with a goal to maximize the amount of the payment and the efficiency with which it is received. By interfacing with the confidence level module 200 (discussed in greater detail below), the acquire billing codes and confidence level use case 122 obtains insurance codes corresponding to the services included in the treatment plan as determined by the determine services to be rendered use case 116. If no further treatment is needed the insurance billing system 100 may determine one or more billing codes for the evaluation service (i.e., the exam) conducted by the provider 104, 106.

Since many insurance companies require that services rendered by the provider are submitted to the insurance company using an accepted or recognized insurance code, the acquire codes and confidence level use case 122 is employed to obtain the most accurate set of insurance codes for the services included in or related to the treatment plan, such that the insurance company to which a reimbursement request is submitted will recognize the service performed and pay the appropriate amount under that particular patient's insurance coverage. Greater accuracy of the insurance claim filing will lead to greater reimbursement for the insured patient and or the provider, both in terms of amount collected and the time it takes to make such collection.

The acquire codes and confidence level use case 122 examines the services identified by the determine services to be rendered use case 116, and, via the confidence level module 200, obtains the correct billing codes for each of those services. The confidence level use case 122 may be employed to acquire confidence levels for codes prior to or after the services are actually rendered. In some embodiments the acquire codes and confidence level use case 122 obtains multiple codes for each of the services, suggests additional codes depending on the nature of the identified service, or returns an indication that a different service should be identified (i.e., the procedure should be identified using a different insurance code) if no insurance code for a particular identified service can be found. The acquire codes and confidence level use case 122 also obtains a confidence level associated with each of the insurance codes, such that the central office 107 may make a determination as to the likelihood that the identified insurance company will return a payment for services performed under the obtained service code. An incorrect code may lead to denial of claim reimbursement or a lesser amount of reimbursement.

The determine patient balance use case 120 case estimates the amount of reimbursement to be made by the insurance company for services rendered (or to be rendered in the future) by the provider and then estimates the balance of fees due by the patient to the provider 104, 106. The balance may be output to the provider via electronic means (e.g., e-mail or facsimile) or merely update the billing information in the patient records database. The determine patient balance use case 120 includes the bill patient for estimated balance use case 118. This is used by the provider 104, 106 or central office 107 to produce an invoice or payment balance for the patient. In some embodiments, this determination is made substantially simultaneously with performance of the service by the service provider. In some embodiments the determination of a patient balance incorporates services provided to the consumer and/or balances of the consumer across multiple service provider locations.

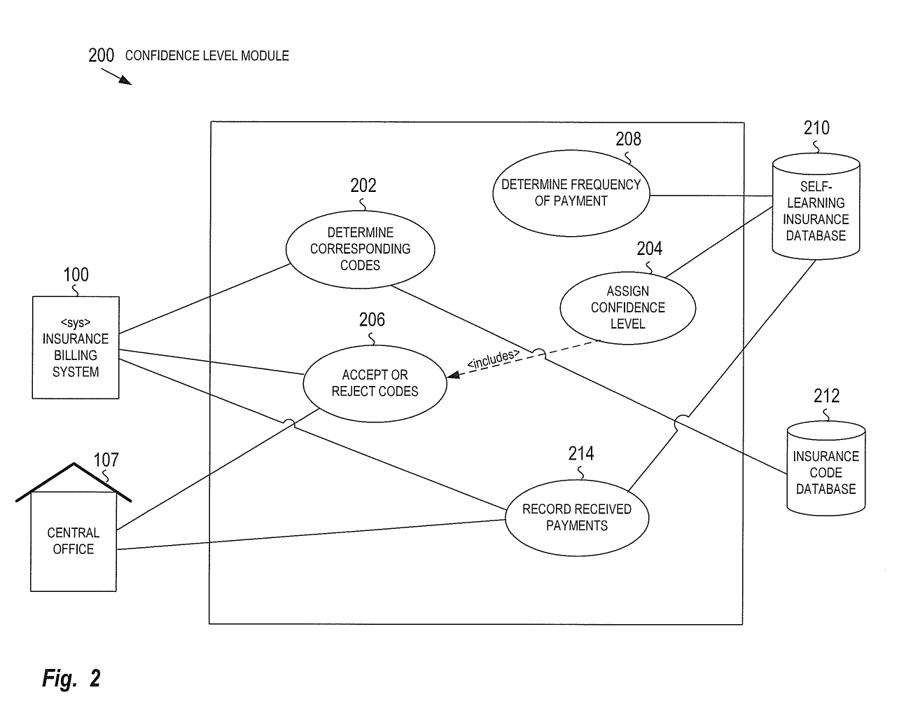

FIG. 2 is a use case diagram of the confidence level module 200 used in one embodiment of the insurance billing system. The confidence level module 200 includes a determine corresponding codes use case 202 that interfaces with an insurance codes database 212. The insurance codes database 212 includes generally industry-accepted insurance billing codes corresponding to services performed by providers. For example, in the present example of a dental provider rendering dental services, the insurance billing codes might conform to those approved or used by the American Dental Association or a similar organization. Those skilled in the art will recognize that any given service or type of service may potentially have multiple corresponding insurance billing codes. For example, each possible billing code may have a different rate of reimbursement for the same service for a given insurance company. Similarly, an individual or group of insurance billing codes may correspond to multiple different services. Moreover, different insurance companies may utilize different codes for the same service or have different names for the same or similar service. Accordingly, the insurance codes database 212 maintains and updates this information for access by the determine corresponding codes use case 202. Based on the services rendered or proposed to be rendered in the determine services to be rendered use case 116, the determine corresponding codes use case 202 interacts with the insurance codes database 212 to identify at least one insurance billing code for each of the rendered or proposed services. As discussed, depending on the particular service or insurance company, there may be multiple different insurance codes chosen from the insurance code database which may be used to file insurance claims. Thus, the determine corresponding codes use case 202 may identify multiple insurance codes for a single service, suggest alternate codes for the same service that could also be applicable or indicate that no suitable insurance codes exist. The determine corresponding codes use case 202 may parse text entered by the provider to determine which services need to be assigned billing codes. For example, the provider may enter a treatment plan in text form and the insurance billing system will conduct an automatic spell check on the text as well as recognize individual services to be rendered and or parse the text to identify services for which billing codes need to be assigned.

The determine frequency of payment use case 208 employs a self-learning insurance database 210 to determine the rate or frequency at which the expected payment is received from a given insurance company for a particular service rendered in response to a payment request submitted under a particular insurance billing code. The self-learning database 210 includes procedure descriptions with corresponding billing codes organized by insurance company, type of insurance, type of plan and/or payment rate. The self-learning database 210 also stores data related to insurance companies and claims submitted and paid through those companies, including: the number of times a particular insurance company has been billed for a particular procedure under a specific code, the number of times that insurance company has paid under that code, the amount paid under that code, and the number of times claims have been denied and/or resubmitted under that code. Using the record received payments use case 214, the self-learning insurance database 210 automatically updates the relevant information based on payments received from insurance companies. Additionally, the self learning database 210 automatically stores or updates the confidence level that corresponds to a particular billing code and procedure each time a payment is received, held, denied or resubmitted. The self learning database 210 may reside on a PC or server, or distributed servers. It could use commercial or open source database platforms such as Oracle, Microsoft SQL Server, MySQL, or PostgreSQL. The insurance billing system 100 may provide external communication to the self learning database 210 through database connections, custom interfaces, or a web application server, or any other communications medium or system generally known in the art.

Using current and/or historical information from the self-learning database 210 (which itself may updated in real-time or substantially real-time), the assign confidence level use case 204 determines confidence levels for the identified insurance codes based on the frequency that the payment amount is received under the chosen codes. The confidence level represents the likelihood of the service provider and/or the consumer receiving payment for a service corresponding to the code identified, selected or assigned for that service. The confidence level may also account for payment being received from a particular insurance carrier for the service billed under the identified code. The confidence levels may be determined using any one or combination of algorithms that analyze and synthesize data from the self-learning database 210 (including frequency of payment data) to develop a prediction of payment based for the identified code for the respective insurance company. The confidence level module 200 will present the central office 107 with confidence levels for each code suggested. The confidence level may be presented as a numeric value in which case, for example, the codes with a higher confidence level will be more likely to receive maximum payment. In one embodiment the confidence level may be a percentage. Alternatively, the confidence level may also be an assigned value or a label, such “High” or “Low”, representing the relative likelihood of maximum payment being received.

The assign confidence level 204 use case includes the accept or reject codes use case 206, which allows the central office 107 to accept or reject the assigned insurance codes based on the assigned confidence levels. In one embodiment, assigned codes may be manually accepted or rejected by an individual in the central office 107 or a provider's office. Such individual may be someone who possesses personal knowledge of the most appropriate codes to under which to file a claim (i.e., an individual with personal experience as to which is the most appropriate code to file under). In one embodiment, the user or central office 107 is prompted with multiple suggested codes, one of which may be selected by the user, or the user may manually enter a billing code. In addition, the central office 107 may either accept one of the codes suggested by the insurance billing system or enter a code manually. The central office 107 may also automatically accept or reject codes based purely on the confidence levels presented by the system. For example, proposed insurance codes with an assigned confidence level below a predetermined threshold or percentage may be rejected by the insurance billing system. A confidence level below some predetermined threshold may prompt the central office 107 to check if that procedure is covered by the patient's insurance company. If the procedure is not covered and the patient carries secondary insurance the central office may obtain a confidence level for the procedure with the secondary provider. If the confidence level is low, the system may also request the provider 104, 106 or the central office 107 to suggest or identify possible additional procedure names or suggested codes, or the system deny implementing the treatment plan altogether. In one embodiment if the confidence level calculated by the system is above a certain threshold, then the system will automatically use that billing code to file the claim.

Once a code is identified and/or selected, the determine patent balance use case 120 uses the code and expected payment information (or rate thereof) from the insurance company corresponding to that code to determine the amount of payment due by the patient 102 to the provider 104, 106. The patient balance is then sent to the provider 104, 106. Before leaving the office, the patient may be billed for services rendered using the bill patient use case 118. In some embodiments, the patient may also be billed for services to be rendered in the future. If the payment received by the provider 104, 106 from the insurance carrier is lower than the estimated amount, the patient 102 will be billed for the difference. If the amount received from the insurance carrier is greater than the amount estimated by the insurance billing system the patient 102 is credited for any overpayment made.

In some embodiments the estimated balance of the consumer, the likelihood of receiving payment or the eligibility of a consumer for insurance coverage for a particular service is determined prior to performing the service, substantially simultaneously with performance of the service, or in real time (or near real time) with respect to the inquiry made by the insurance billing system 100. For example, the confidence level of a particular service for a particular insurance company may be applied to determine consumer insurance eligibility or whether the consumer otherwise have coverage for that particular service and what the expected reimbursement rate is. Furthermore, the insurance billing system 100 may attempt to verify coverage or determine predicted payments by identifying alternate insurance codes (e.g., if an initial code yielded poor results) for a given service by determining the predicted likelihood of payment.

In some embodiments, the confidence level of an insurance code is applied to assist in consumer and/or service provider scheduling. For example, if it is determined that there is a low likelihood of receiving payment from an insurance company for a service for a consumer, the service provider may choose to adjust his schedule accordingly (e.g., perform another procedure first, group certain types of procedures together, refuse to perform a procedure altogether, etc.). Such scheduling changes in view of predicted likelihood of receiving payment may be implemented across multiple service provider locations. Similarly, scheduling considerations in view of predicted likelihood of receiving payment may be implemented by a consumer, also accounting for the multiple service provider locations. The insurance billing system 100 further permits personalization and/or preferences of service providers across provider locations, including aspects such as patient type, patient load, desired risk level in assigning insurance codes, etc.

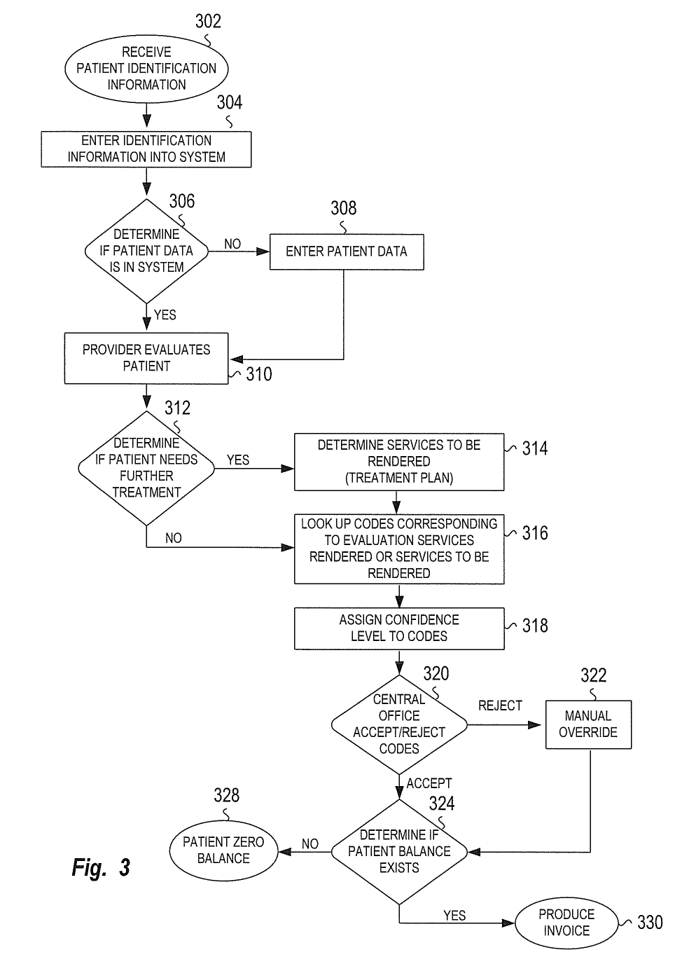

FIG. 3 is a flow chart of the process of evaluating a patient and determining a patient's balance due for services rendered, as well as for services to be rendered in the future. For the purposes of this example, the process is explained with respect to a health care provider visit. In the receive patient identification information step 302, identifying information is gathered that can be entered into the system to update the patient records on file and/or build new patient records. This may include patient name, date of birth, social security number or other identifying information. Once this identifying information is entered into the system at step 304, it can be determined if the patient's records exist in the system 306. Otherwise, a record of the patient is created and the appropriate data entered into the system 308. Once a patient's records exist, the provider can then evaluate the patient 310. In evaluating the patient, the provider examines the patient, and addresses any symptoms the patient is experiencing. The provider determines what treatment if any the patient is in need of at step 312. Next, the provider formulates a treatment plan as to what services will be rendered and when 314. The system then proceeds to look up corresponding billing codes for the services determined in the treatment plan 316. The system will assign each retrieved code a confidence level 318 based on the self-learning insurance database. Once all codes are assigned confidence levels, the central office may accept or reject each code 320. The central office may use the confidence level, as well as personal knowledge, to determine whether to accept or reject each code. If the central office rejects a code, they will perform a manual override 322 of the billing code. Once the codes are accepted or overridden, the system will determine if a patient balance exists 324. The system uses the self-learning insurance database to determine how often a particular insurance carrier has made payment for a particular service under a specific code. The system will also determine the average payment amount received. Using this data, the system will calculate the total patient balance for the prescribed treatment plan. If a balance does exist, the system will produce and invoice for the patient 330. If a balance does not exist the insurance billing system will inform the user that there is a zero patient balance 328.

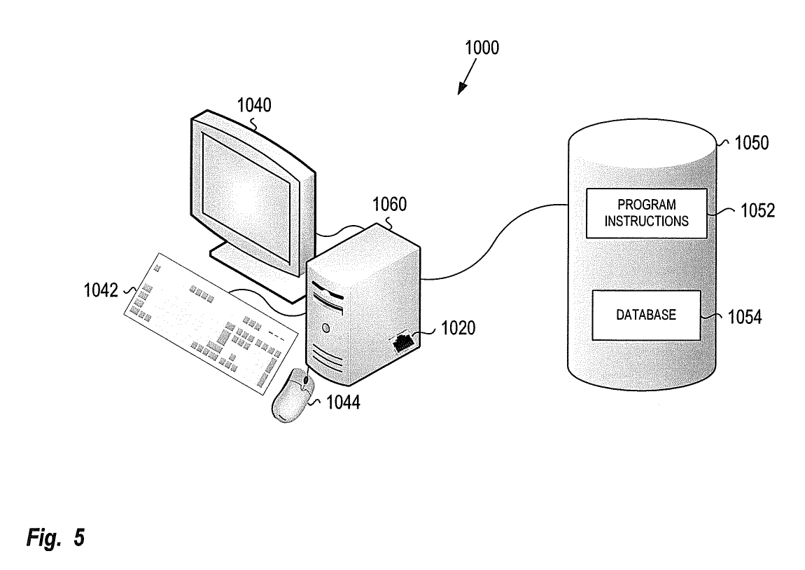

FIG. 5 is a block diagram illustrating a computer system 1000 for realization of a computer-implemented apparatus that may form all or a portion of one or more implementation(s) or embodiment(s) of the present disclosure. The computer system 1000 includes a computer 1060, a keyboard 1042, a mouse 1044, and a display device (e.g., computer monitor) 1040 through which the computer 1060 may receive input/provide output, for example to a user, operator or another computer or system (not shown). Input/output devices such as the display device 1040, keyboard 1042, the mouse 1044, and other means or mechanisms (e.g., touch screen interface) through which interaction with the computer system 1000 may occur are generally known in the art, and a detailed discussion thereof is omitted here for convenience only and should not be considered limiting. The computer 1060 includes a network port 1020 for connecting the computer to an internal or external network, such as, for example the network 400. The computer 1060 is connected to a storage device 1050 that includes program instructions 1052 for software application(s) that provides the logical functions of the computer-implemented apparatus and/or method(s) of the present disclosure. The storage device 1050 also contains a database 1054 for storing data.

Those skilled in the art will recognize that the program instructions 1052 for software applications implementing all or a portion of one or more embodiment(s) of the present disclosure may be written in a programming language such as Java or C++, and that the database 1054 may be implemented with a database package such as Microsoft Access™ or a database management system (DBMS) such as Microsoft SQL Server™, Microsoft SQL Server CE™, IBM DB2™, mySQL or postgreSQL.

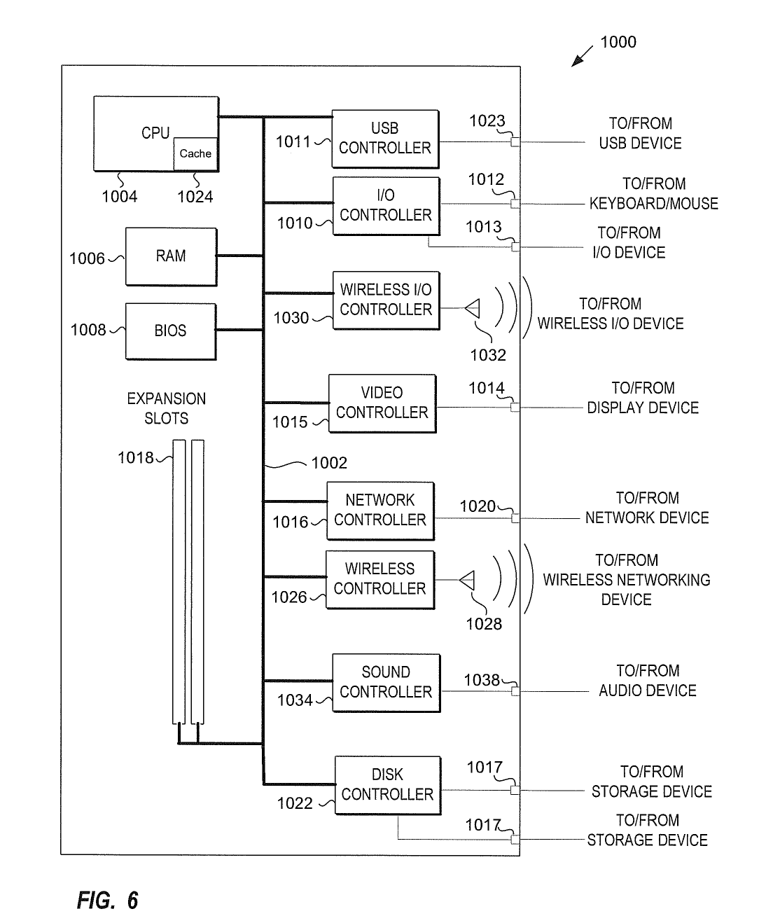

FIG. 6 is a block diagram illustrating a computer architecture of the system 1000 through which the embodiments of the insurance billing system 100, including the confidence level module 200 and the self-learning database 210, may be implemented. A system bus 1002 transports data amongst the Central Processing Unit (CPU) 1004, RAM 1006, the Basic Input Output System (BIOS) 1008 and other components. The CPU 1004 may include a cache memory component 1024. The computer system 1000 may include one or more external storage ports 1017 for accessing a hard disk drive (HDD), optical storage drive (e.g., CD-ROM, DVD-ROM, DVD-RW), flash memory, tape device, or other storage device (not shown). The relevant storage device(s) are connected through the external storage port 1017 which is connected to the system bus 1002 via a disk controller 1022. A keyboard and/or pointing device (e.g., mouse, touch pad) (see FIG. 5) can be connected to the keyboard/mouse port(s) 1012, and other I/O devices could be connected to additional I/O port(s) 1013, which are connected to the system bus 1002 through the I/O controller 1005. Additional ports or devices, such as serial ports, parallel ports, firewire adapters, or biometric devices (not shown), may be utilized through the I/O controller 1010. A display device (see FIG. 5) can be connected to a display device port 1014 which is connected to the system bus 1002 through the video controller 1015. A network device (not shown), including but not limited to an Ethernet device or other device having networking capability, can be connected to a network port 1020 which is connected through the network controller 1016 to the system bus 1002. The computer system 1000 may be wirelessly connected to a network device that is configured for wireless operation (not shown), including but not limited to wireless routers, using an antenna 1028 connected to a wireless controller 1026 connected to the system bus 1002, where the antenna transmits/receives signals to/from the network device. The computer system 1000 may include one or more USB ports 1023. A USB device (not shown), including but not limited to a printer, scanner, keyboard, mouse, digital camera, storage device, PDA, cellular phone, biometric device, webcam, and I/O adapters can be connected to the USB port 1023 which is connected to the system bus 1002 through the USB controller 1011. Other devices, such as cellular phones, PDAs, and other portable devices may also be connected wirelessly via a wireless I/O antenna 1032 that is connected to a wireless I/O controller 1030. Examples of wireless I/O technologies include, but are not limited to, Bluetooth, Infrared (IR), and Radio-Frequency (RF). Audio devices, such as microphones, speakers, or headphones may be connected to a sound port 1038 that is connected to a sound controller 1034 that is connected to the system bus 1002. Expansion slots 1018 can include Industry Standard Architecture (ISA) slots, Peripheral Component Interconnect (PCI) expansion slots, PCI Express expansion slots, Accelerated Graphics Port (AGP) slots or any other slot generally known in the art to allow additional cards to be placed into the computer system 1000. These slots can be used to connect network cards, video cards, sound cards, modems and any other peripheral devices generally used with a computer. The computer system 1000 also includes a source of power (not shown), including but not limited to a power supply connected to an external source of power, and/or an internal or external battery. These devices are generally well-know to those skilled in the art, and a detailed discussion thereof is omitted here for convenience only and should not be considered limiting.

The embodiments of the present disclosure may be implemented with any combination of hardware and software. If implemented as a computer-implemented apparatus, the present disclosure is implemented using means for performing all of the steps and functions described above.

The embodiments of the present disclosure can be included in an article of manufacture (e.g., one or more computer program products) having, for instance, computer useable or computer readable media. The media has embodied therein, for instance, computer readable program code means, including computer-executable instructions, for providing and facilitating the mechanisms of the embodiments of the present disclosure. The article of manufacture can be included as part of a computer system or sold separately.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of the present disclosure is not limited to the particular examples and implementations disclosed herein, but is intended to cover modifications within the spirit and scope thereof as defined by the appended claims and any and all equivalents thereof.

We claim:

1. A method of billing consumers for services rendered by a service provider, the method comprising:
(a) determining at least one service to be rendered to the consumer;
(b) identifying, by a computer, at least one code corresponding to the at least one service;
(c) determining, by the computer, a confidence level for each of the at least one codes;
(d) assigning, by the computer, one of the identified codes to each of the at least one services, each assigned code corresponding to the respective service and being based at least in part on the corresponding confidence level; and
(e) determining an estimated consumer balance for the services rendered in view of the assigning of step (d).

2. The method of claim 1, further comprising:
(f) determining whether to reject the at least one identified code based at least in part on the confidence level corresponding to the at least one identified code; and
(g) assigning an alternate code to the corresponding service if the at least one identified code is rejected.

3. The method of claim 1, further comprising:
(f) determining an amount owed by the consumer for performance of the at least one service based on the assigned code.

4. The method of claim 1, wherein the confidence level includes a representation of likelihood of the service provider receiving payment for the service corresponding to the respective at least one code.

5. The method of claim 1, wherein the at least one code is an industry accepted identifier representing the corresponding service.

6. The method of claim 5, wherein the at least one code is an insurance billing code.

7. The method of claim 1, wherein the at least one service is a dental procedure.

8. The method of claim 1, wherein the consumer is a dental patient.

9. The method of claim 1, wherein the determining of step (e) is accomplished substantially simultaneously with performance of the at least one service.

10. The method of claim 1, wherein the determination of step (e) accounts for services provided across multiple service provider locations.

11. A method of determining consumer insurance eligibility for at least one service to be rendered to a consumer by a service provider, the method comprising:
(a) identifying the at least one service to be rendered to the consumer by the service provider;
(b) identifying, by a computer, at least one insurance code corresponding to the at least one service;
(c) determining, by the computer, a confidence level for each of the at least one insurance codes;
(d) predicting, by the computer, likelihood of payment to the service provider for the at least one service based on the at least one insurance code in view of the assigned confidence level; and
(e) determining, based on the predicting of step (d), whether the consumer has insurance coverage for the at least one service.

12. The method of claim 11, further comprising:
(f) determining whether to perform the at least one service based on the determining of step (e).

13. The method of claim 11, wherein the determining of step (e) occurs prior to performing the at least one service.

14. The method of claim 11, further comprising:
(f) assigning one of the identified codes to each of the at least one services, each assigned code corresponding to the respective service,
wherein step (e) includes determining that the consumer has sufficient insurance coverage for the at least one service in view of the assigning of step (f).

15. The method of claim 11, further comprising:
(f) identifying an alternate insurance code corresponding to the at least one service; and
(g) repeating the determination of step (e) in view of the alternate insurance code and its corresponding confidence level.

16. The method of claim 11, wherein the confidence level includes a representation of likelihood of the service provider receiving payment for the service corresponding to the respective at least one code.

17. The method of claim 11, wherein the at least one code is an industry accepted identifier representing the corresponding service.

18. The method of claim 11, wherein the at least one service is a dental procedure.

19. The method of claim 11, wherein the predicting likelihood of payment is made in substantially real time.

20. The method of claim 11, further comprising:
(f) personalizing a procedure schedule of the service provider in view of the determination of step (e).

21. The method of claim 20, wherein the procedure schedule accounts for multiple service provider locations.

22. The method of claim 11, further comprising:
(f) personalizing a service schedule of the consumer in view of the determination of step (e).
